(19) United States
(12) Patent Application Publication
(10) Pub. No.: US 2014/0330709 A1
(43) Pub. Date: Nov. 6, 2014

(54) ONLINE STREAM HONEY POT CAPTURE

(71) Applicants: Wayne D. Lonstein, Ellenville, NY (US); Julie C. Lonstein, Ellenville, NY (US)

(72) Inventors: Wayne D. Lonstein, Ellenville, NY (US); Julie C. Lonstein, Ellenville, NY (US)

(21) Appl. No.: 14/304,542

(22) Filed: Jun. 13, 2014

Related U.S. Application Data
(62) Division of application No. 13/118,324, filed on May 27, 2011.

(51) Int. Cl. G06Q 50/18; G06Q 20/10

(52) U.S. Cl. CPC G06Q 50/184; G06Q 20/102
USPC 705/40

(57) ABSTRACT

An online stream honey pot capture method includes placing content sought to be protected on a honey pot website, providing access to a user who has been advised that the content is unlicensed, receiving contact information from the user, and obtaining payment from the user for his access of the unlicensed content.

### BACKGROUND OF THE INVENTION

The present invention generally relates to systems and methods for protecting media content, and more particularly, to online stream honey pot capture systems, methods, and computer program product.

Modern computer users have access to improperly obtained or unlicensed media content that is readily downloaded without remuneration to a content owner or licensor. Content owners do not have a method of identifying users who knowingly download unlicensed content due to a semi-anonymous nature of Internet requests and due to a ubiquitous availability of public internet access.

As can be seen, there is a need for an improved system, method, and computer program product that allows a content owner to identify users who seek to download unlicensed media content and obtain remuneration therefrom

### SUMMARY OF THE INVENTION

In one aspect of the present invention, a method of operating an online stream honey pot capture is provided comprising placing content sought to be protected on a honey pot website; providing access to the content to an unlicensed user, wherein the unlicensed user is a pirate; advising the pirate that the content is unlicensed; receiving contact information for the pirate; and obtaining lawful remuneration from the pirate.

In another aspect of the present invention, an online stream honey pot capture system is provided comprising a honey pot core; a streaming media server in communication with the honey pot core; a web server in communication with the streaming media server and obscuring the streaming media server; and a kill switch module in communication with the honey pot core, the honey pot core operable to direct the streaming media server to store media content sought to be protected; direct the streaming media server to serve up media content; direct the kill switch module to reduce access to the media content for a user; advise the user that the media content is unlicensed; receive contact information for the user; and obtain compensation from the user for accessing the media content.

In still another aspect of the present invention, a computer program product for providing an online stream honey pot capture, the computer program product comprising a computer readable storage medium having computer readable program code embodied therewith, the computer readable program code comprising computer readable program code configured to instruct an application server to store media content sought to be protected; advise a user that the media content is unlicensed; provide the user access to the media content; receive identifying information for the user; and obtain compensation for the accessed media content.

These and other features, aspects and advantages of the present invention will become better understood with reference to the following drawings, description and claims.

### BRIEF DESCRIPTION OF THE DRAWINGS

FIG. 1 is a schematic diagram of an online stream honey pot capture system according to an exemplary embodiment of the present invention;

FIG. 2 is schematic diagram of aspects of the online stream honey pot capture system shown in FIG. 1;

FIG. 3 is a schematic diagram of aspects of the online stream honey pot system shown in FIG. 1; and

FIG. 4 is a process flow diagram of an online stream honey pot capture method according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide an online stream honey pot capture method that includes placing content sought to be protected on a honey pot website, providing access to a user who has been advised that the content is unlicensed, receiving contact information from the user, and obtaining payment from the user for his access of the unlicensed content.

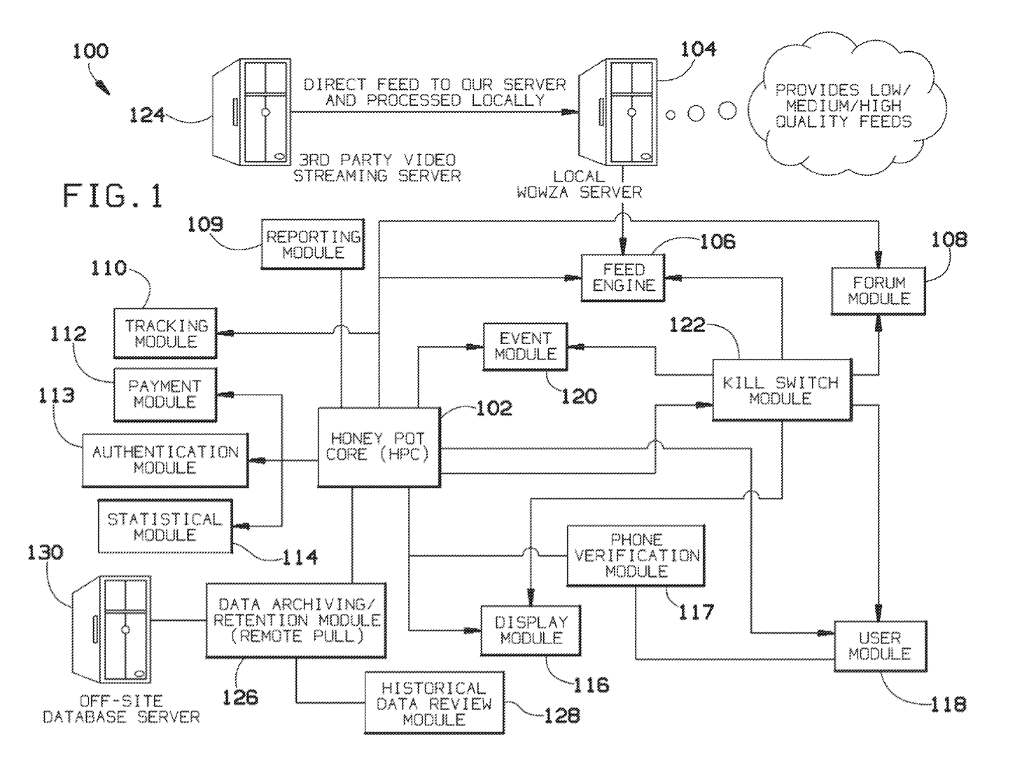

Referring now to FIG. 1, a schematic diagram is shown of an online stream honey pot capture system 100 according to an exemplary embodiment of the present invention. Capture system 100 may have a honey pot core 102, which may be in communication with and invoke a plurality of modules and devices including, for example, a local server 104, a feed engine 106, a forum module 108, a reporting module 109, a tracking module 110, a payment module 112, an authentication module 113, a statistical module, 114, a display module 116, a phone verification module 117, a user module 118, an event module 120, a kill switch module 122, and a data archiving and retention module 126. Data archiving and retention module 126 may be in communication with and invoke a historical data review module 128 and a database server 130. The foregoing elements may provide honey pot core 102 with the user interface and communication functionality to allow honey pot core 102 to communicate with a third party video streaming server 124 or a user (not pictured). Streaming server 124 may be a web server, for example, configured to store and serve up streaming or static media for local server 104, which may be a web server or application server on which feed engine 106, for example, may reside.

According to some exemplary embodiments, honey pot core 102, feed engine 106, forum module 108, reporting module 109, tracking module 110, payment module 112, authentication module 113, statistical module, 114, display module 116, phone verification module 117, user module 118, event module 120, kill switch module 122, and data archiving and retention module 126 may be software or hardware components embodied in an application server or a web server, presented through a honey pot website, and configured to perform functions or execute tasks including, for example, invoking modules described herein, administering a media stream, controlling an online user forum, controlling reporting tasks, controlling user tracking sessions and information; managing user payment options and receipt thereof, performing user authentication, calculating usage statistics, controlling a display of website components, verifying a phone number, managing user settings, controlling website and user events, controlling user access to media; and archiving user information and statistics respectively.

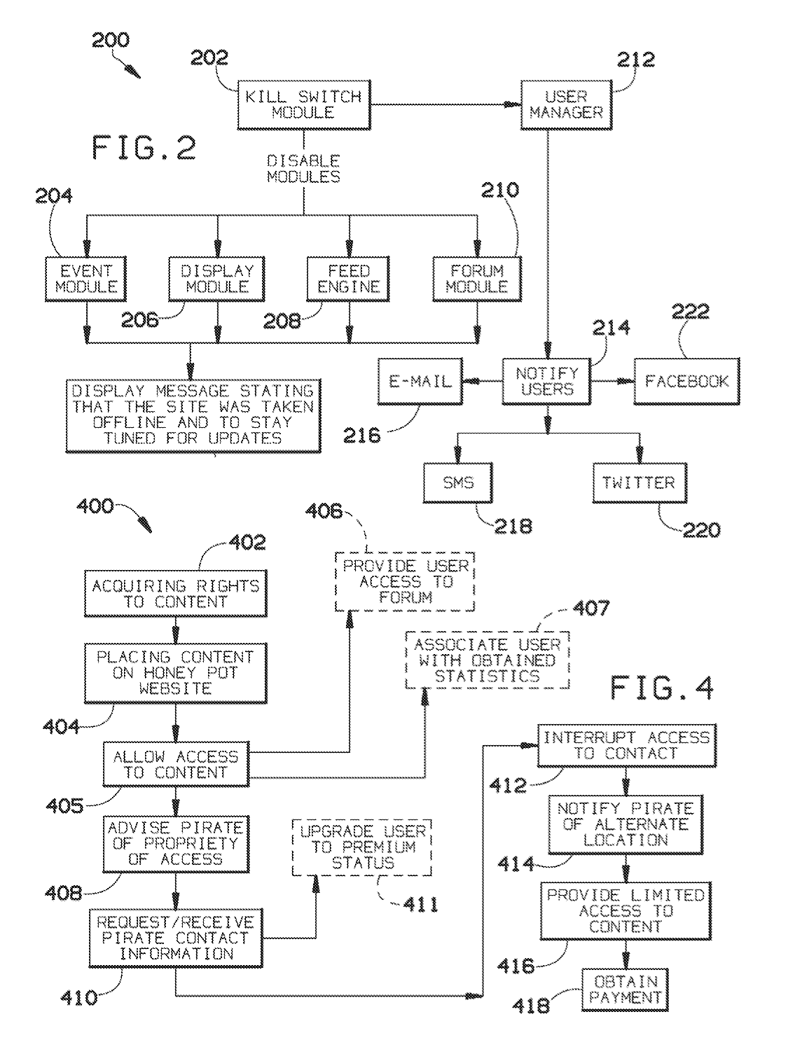

Referring now to FIG. 2, a schematic diagram 200 of aspects of system 100 of FIG. 1 are shown. A kill switch module 202 may be in communication with, and invoke, a plurality of modules including, for example, an event module 204, a display module 206, a feed engine 208, and a forum module 210. When invoked by kill switch module 202, the plurality of modules 204, 206, 208, 210 may be configured to exhibit shutdown or inactive portions of the honey pot website, display a predetermined message to a user, disrupt or alter a media feed, and activate a predetermined protocol on the user forums, respectively. The predetermined message may state that the honey pot website was taken offline and that users may find their content on an alternative website. Kill switch module 202 may be in communication with a user manager 212, which may invoke a notify users module 214 that may implement communication methods including, for example, email 216, short message service 218 (SMS), and social networking means including Twitter® 220 and Facebook® 222. User manager 212 and user module 118 may be, configured to manage all aspects of a user profile including login information, geographic information, identity, email, locale, phone number, and address, for example.

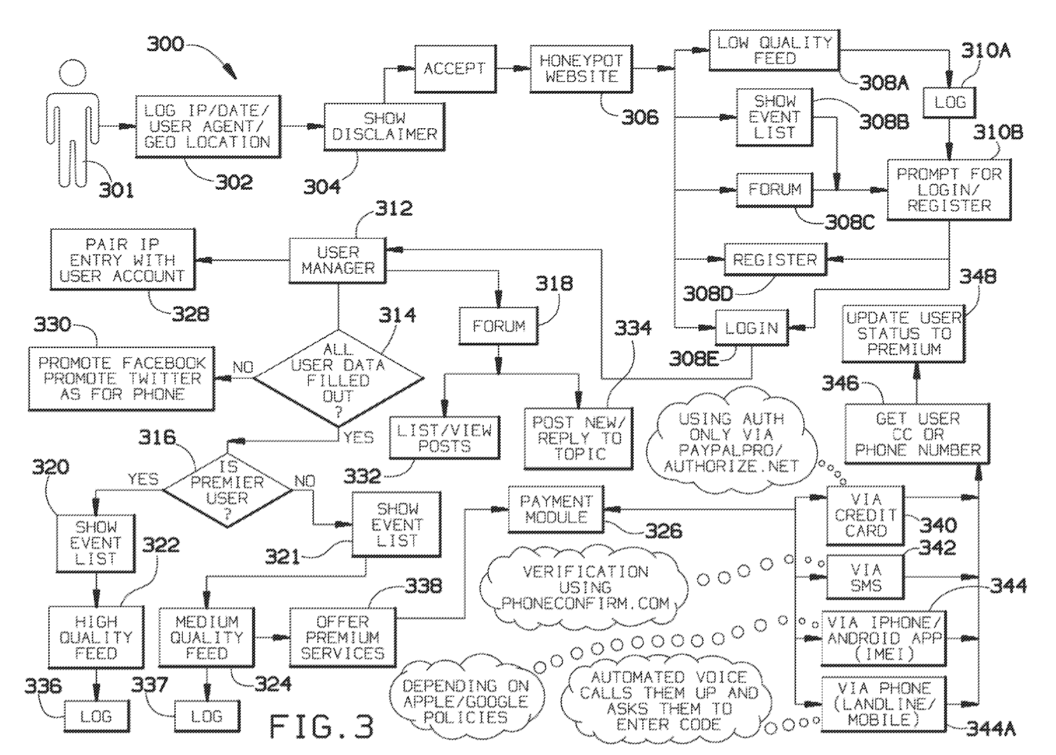

Referring now to FIG. 3, a schematic diagram 300 is shown that illustrates a relationship between the modules and processes according to an exemplary embodiment of the present invention. A user 301 may be associated with identifying information 302 that may include an internet protocol (IP) address, a user agent, a geographic location, and a date/time stamp of any activity of user 301. A disclaimer may be presented to user 301 of his unlicensed access to content in step 304. User 301 may be given access to a honey pot website 306, which may have features including a low quality content feed 308a, an event list 308b, a user discussion forum 308c, a register 308d, and a login 308e. Activity or access of low quality content feed 308a may be documented in a log 310a. The foregoing features 308a-e may require a login, which invoke a login or register prompt 310b. Login 308e may be in communication with a user manager 312, which may enable a forum 318 or may make determinations including whether user data was completed 314 or an access level of a user 316. If user 301 has not completed all his user data, honey pot website 306 may be promoted through social networking means 330 (e.g., using Facebook®, Twitter®) that may target user 301. Services or content of honey pot website 306 may be promoted through listing/viewing posts 332 or posting/replying to a topic 334.

Modules including event lists 320, 321 may be activated, which may link to a high quality feed 322, and a medium quality feed 324 respectively, wherein event list 320 may be activated, and high quality feed 322 may be shown if it is determined that user 301 is a premium user. During all user 301 interactions with honey pot web site 306, forensic information including the originating internet protocol (IP) address of user 301 may be recorded and paired with the user's account 328. Activity or access of high quality content feed 322 or medium quality feed 324 may be documented in logs 336 and 337 respectively.

According to some exemplary embodiments of the present invention, user 301 may be offered an option of premium services 338, which may include access to higher quality content, a broader range of content, access to full content, or access to view or use restricted aspects of the honey pot website, for example. Upon user 301 selecting the option, a payment module 326 may be invoked that may request payment via credit card 340, via SMS 342, via mobile phone 344, or via conventional phone 344a. A user credit card (CC) or phone number 346 may also be required to update a user status to premium 348.

Referring now to FIG. 4, a process flow diagram of an online stream honey pot capture method 400 is shown according to an exemplary embodiment of the present invention. Capture method 400 may include acquiring rights (e.g., license, assignment), 402, from a content owner for content sought to be protected. The content may include, for example, digital or analog media comprising images, audio, video or any combination thereof. The content sought to be protected may be placed on a honey pot website, 404, which may be made accessible to an individual who may not have a corresponding license, 405. The individual or user that accesses content in an unauthorized manner (i.e., without a corresponding license) may be deemed a pirate. According to some exemplary embodiments, only a portion of the content (e.g., excerpts, vignettes, redacted versions) may be accessible by the pirate. According to other exemplary embodiments, lower quality versions of the content (e.g., decimated versions) may be accessible by the pirate.

The user may be provided access to a user or discussion forum, 406. The user's activity on the honey pot website may generate statistical or forensic evidence that may be collected and may include an internet protocol (IP) address, a date or timestamp of the user's access, the user's browser, and the user's service provider, for example. The collected statistical or forensic evidence may be associated with the user or user account, 407. Capture method 400 may include advising the user of the impropriety of accessing the unlicensed content, 408, and may include requesting contact or identity information, 410. An unlicensed access of the content may deem the user a pirate. The contact or identity information may be posed as being for the purpose of advising the user of alternative sites or status updates if access to the honey post website becomes interrupted, and the information may be required for an upgrade to premium status. In response to the user providing the requested contact information, the user may be updated to premium status, 411.

Capture method 400 may include interrupting access to the portion of the content, 412, which may include advising the pirate, using the received contact information, of an alternative location where the portion of the content may be accessed, 414. The alternative location may be a legitimate site or a second honey pot website, where additional identifying information may be obtained from the pirate. The pirate may continue to have limited access to the content at the original location for a period of time, 416. Upon acquiring sufficient identifying information for the pirate, the method may arrange for payment to be obtained therefrom, 418, for the pirate's access to the unlicensed content. Obtaining payment may involve proffering, to the pirate, civil recourse or lawful purchase of the content thereby.

It should be understood, of course, that the foregoing relates to exemplary embodiments of the invention and that modifications may be made without departing from the spirit and scope of the invention as set forth in the following claims.

1-7. (canceled)

8. A system of an online stream honey pot capture system, comprising:
a honey pot core;
a streaming media server in communication with the honey pot core;
a web server in communication with the streaming media server and obscuring the streaming media server; and
a kill switch module in communication with the honey pot core, the honey pot core operable to:
direct the streaming media server to store media content sought to be protected;
direct the streaming media server to serve up media content;
direct the kill switch module to reduce access to the media content for a user;
advise the user that the media content is unlicensed;
receive contact information for the user; and
obtain compensation from the user for accessing the media content.

9. The system of claim 8, the honey pot core further comprising:
a user manager; and
a payment module.

10. The system of claim 8, further comprising a data archiving module, the data archiving module comprising a database server, wherein the honey pot core is operable to direct the database server to archive received contact information for the user.

11. The system of claim 8, further comprising a second streaming media server in communication with the honey pot core.

12. A computer program product for providing an online stream honey pot capture, the computer program product, comprising:
a computer readable storage medium having computer readable program code embodied therewith, the computer readable program code comprising:
computer readable program code configured to instruct an application server to:
store media content sought to be protected;
advise a user that the media content is unlicensed;
provide the user access to the media content;
receive identifying information for the user; and
obtain compensation for the accessed media content.

13. The computer program product of claim 12, wherein the computer readable program code is further configured to instruct the application server to:
activate a kill switch module, wherein activating the kill switch module removes access to the media content; and
redirect the user to a payment module.

14. The computer program product of claim 12, wherein the computer readable program code is further configured to instruct the application server to:
associate the user with forensic information obtained on the user's access of the media content; and
store information relating to the user's activities to a database.

15. The computer program product of claim 12, wherein the computer readable program code is further configured to instruct the application server to:
provide access to the media content for a limited time; and
provide a premium status upgrade option to the user.
